(19) United States
(12) Patent Application Publication
(10) Pub. No.: US 2023/0191766 A1
(43) Pub. Date: Jun. 22, 2023

(54) LAMINATION DEVICE

(71) Applicant: Guangdong Willing Technology Corporation, Huizhou (CN)

(72) Inventor: JINGNONG YE, Huizhou (CN)

(21) Appl. No.: 17/556,988

(22) Filed: Dec. 20, 2021

(51) Int. Cl. B32B 37/00; B32B 37/06

(52) U.S. Cl. CPC B32B 37/0046; B32B 37/06

(57) ABSTRACT

The lamination device includes a main member with an input slot and an output slot. Inside the main member, there are a left plate, a right plate, and a power element. A first input shaft, a second input shaft, a first output shaft, and a second output shaft are pivotally positioned between the left plate and the right plate. The first input shaft and the first output shaft are surrounded by a first transmission belt, and the second input shaft and the second output shaft are surrounded by a second transmission belt. The first transmission belt and the second transmission belt are configured with heater members, each including a heating element and a pre-heat piece. The to-be-laminated objected is inserted into the input slot, carried between the first transmission belt and the second transmission belt, and thermally sealed by the heater members.

### BACKGROUND OF THE INVENTION

### (A) Technical Field of the Invention

The present invention is generally related to lamination devices, and more particular to a lamination device providing fast thermal sealing.

### (B) Description of the Prior Art

For a conventional lamination device, an object to be laminated, usually a piece of paper or a picture, is first sandwiched in a plastic wrapping and then fed through the lamination device, where the object is thermally sealed in the plastic wrapping by heating element of the lamination device for protection and preservation.

Usually, there is a pair of adjacent rollers, and the object is delivered between the rollers and then into the lamination device. Heaters are, therefore, configured besides the rollers for thermal sealing.

This type of thermal sealing requires that the lamination device be turned on in advance for a while for pre-heating. In other words, if the lamination device is used immediately, the thermal sealing may not be satisfactory, as its heater does not have a high enough temperature.

### SUMMARY OF THE INVENTION

A major objective of the present invention is to achieve fast thermal sealing through efficient pre-heating by heating elements and pre-heat pieces.

To achieve the objective, the lamination device includes a main member, an input slot on the main member, an output slot on the main member opposite to the input slot, a left plate inside the main member, a right plate inside the main member, a first input shaft inside the main member whose two ends are pivotally joined to the left plate and the right plate, a second input shaft inside the main member whose two ends are pivotally joined to the left plate and the right plate, a first output shaft inside the main member whose two ends are pivotally joined to the left plate and the right plate, a second output shaft inside the main member whose two ends are pivotally joined to the left plate and the right plate, a power element inside the main member coupling and engaging the first output shaft and second output shaft, a first transmission belt surrounding the first input shaft and the first output shaft, a second transmission belt surrounding the second input shaft and second output shaft, and a number of heater members respectively surrounded by the first transmission belt and the second transmission belt, where each heater member includes a heating element and a pre-heat piece wrapping the heating element.

A to-be-laminated object is inserted into the main member through the input slot. In the meantime, the power element spins the first output shaft and the second output shaft, which in turn drive the first transmission belt and the second transmission belt to roll, thereby carrying the object to move. The first transmission belt and the second transmission belt also engages the first input shaft and second input shaft to spin, and the thermally sealed object is delivered out from the output slot.

To achieve thermal sealing, the heater members are turned on so that the heating elements produce heat for sealing. The heat is also conducted to the pre-heat pieces, the first transmission belt, and the second transmission belt. As the to-be-laminated object is carried between the first transmission belt and the second transmission belt, it first reaches the pre-heat pieces and as such pre-heated. The object then reaches the heating elements for thermal sealing. Therefore, the lamination device provides effective pre-heating without turning on the lamination device in advance.

Through the above-described design, the disclosed lamination device overcomes the problem of inferior efficiency suffered by conventional lamination devices

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective diagram showing a lamination device according to a first embodiment of the present invention.

FIG. 2 is a perspective breakdown diagram showing the lamination device of FIG. 1.

FIG. 3 is a cross-sectional diagram showing the lamination device of FIG. 1.

FIG. 4 is a cross-sectional diagram showing an operation scenario of the lamination device of FIG. 1.

FIG. 5 is a perspective diagram showing a lamination device according to a second embodiment of the present invention.

FIG. 6 is a perspective breakdown diagram showing the lamination device of FIG. 5.

FIG. 7 is a cross-sectional diagram showing an operation scenario of the lamination device of FIG. 5.

FIG. 8 is another cross-sectional diagram showing an operation scenario of the lamination device of FIG. 5.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

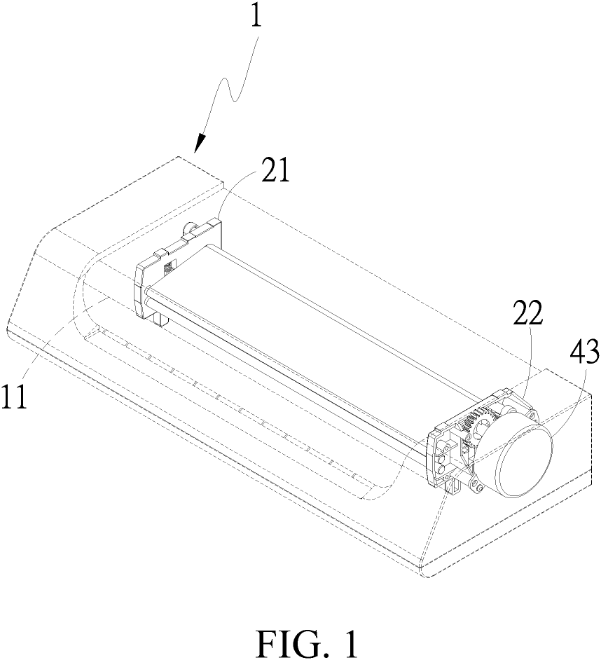

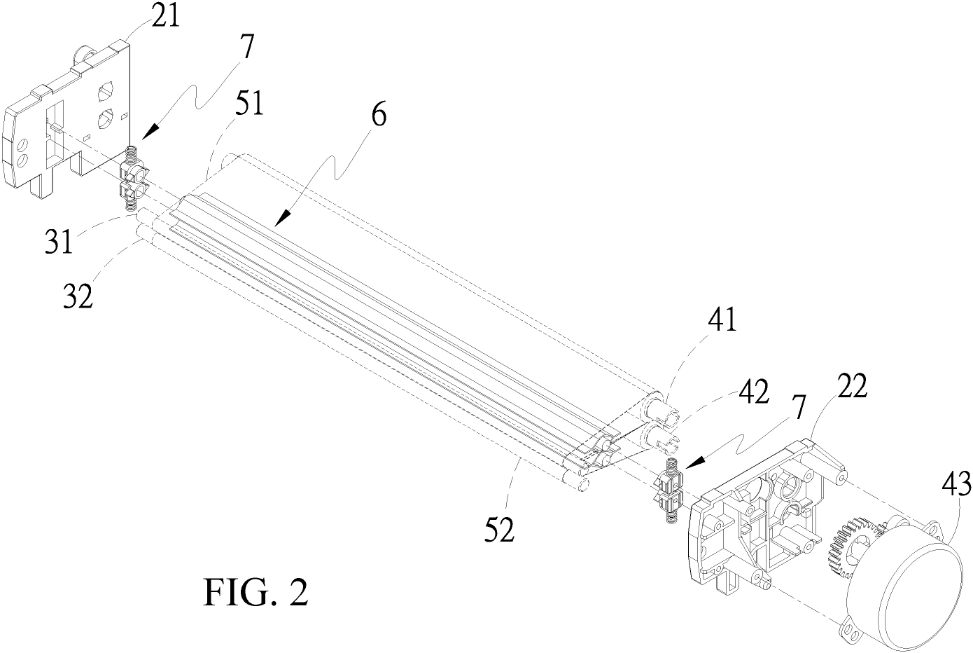

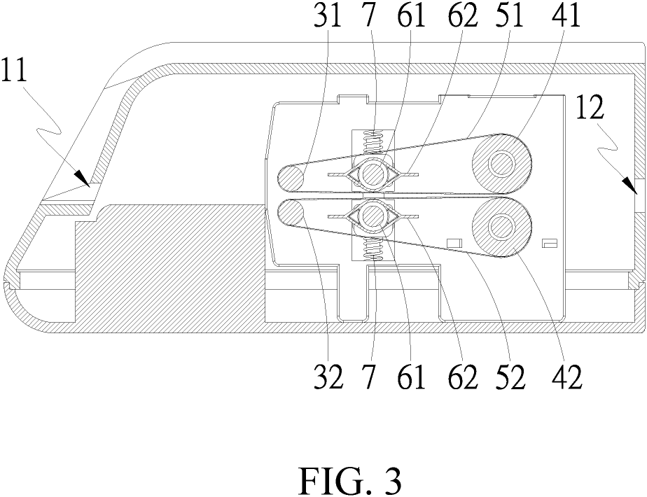

As shown in FIGS. 1 to 3, a lamination device according to a first embodiment of the present invention includes:
a main member 1;
an input slot 11 on a front side of the main member 1;
an output slot 12 on a back side of the main member 1 opposite to the input slot 11;
a left plate 21 inside the main member 1 and adjacent to a left side of the main member;
a right plate 22 inside the main member 1 and adjacent to a right side of the main member opposite to the left plate 21;
a first input shaft 31 inside the main member 1 whose two ends pivotally joined to the left plate 21 and the right plate 22, respectively;
a second input shaft 32 inside the main member 1 whose two ends pivotally joined to the left plate 21 and the right plate 22, respectively;
a first output shaft 41 inside the main member 1 whose two ends pivotally joined to the left plate 21 and the right plate 22, respectively;
a second output shaft 42 inside the main member 1 whose two ends pivotally joined to the left plate 21 and the right plate 22, respectively, where, in the present embodiment, the first output shaft 41 and the second output shaft 42 have their cross-sectional radiuses greater than those of the first input shaft 31 and the second input shaft 32, and the first output shaft 41 and the second output shaft 42 are positioned laterally behind the first input shaft 31 and the second input shaft 32 (i.e., closer to the back side of the main member 1);
a power element 43 inside the main member 1 engaging the first output shaft 41 and second output shaft 42 where, in the present embodiment, the power element 43 is a servo motor and the power element 43 also engages the first input shaft 31 and second input shaft 32 through gears;
a first transmission belt 51 surrounding the first input shaft 31 and first output shaft 41;
a second transmission belt 52 surrounding the second input shaft 32 and second output shaft 42;
a number of elongated heater members 6 inside the main member 1 and respectively surrounded by the first transmission belt 51 and the second transmission belt 52, where each heater member 6 has its two ends movably joined to the left plate and the right plate respectively, and includes an elongated heating element 61 and a pre-heat piece 62 wrapping the heating element 61; and
a number of elastic support elements 7 respectively on the left plate 21 and the right plate 22 supporting the two ends of the heater members 6.

The operation of the lamination device is described as follows.

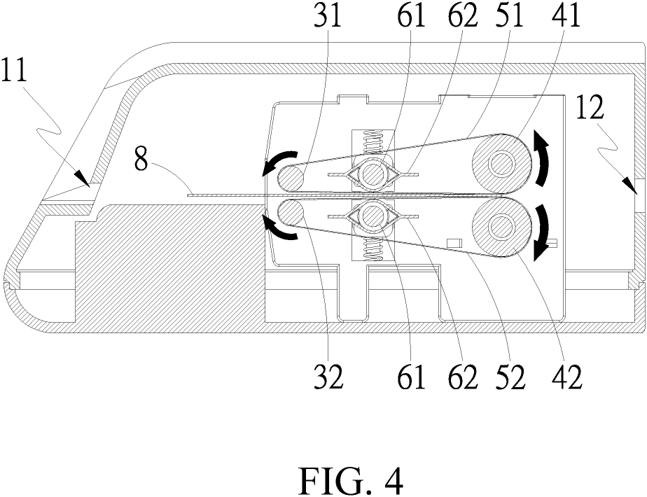

As shown in FIGS. 1 to 4, a to-be-laminated object 8 is inserted into the main member 1 through the input slot 11. In the meantime, the power element 43 engages the first output shaft 41 and the second output shaft 42 to spin, which in turn drives the first transmission belt 51 and the second transmission belt 52 to roll. The first transmission belt 51 and the second transmission belt 52 in turn drive the first input shaft 31 and the second input shaft 32 to spin, thereby moving the to-be-laminated object 8 between the first transmission belt 51 and the second transmission belt 52.

To conduct thermal sealing, the heating elements 61 of the heater members 6 are turned on while the elastic support elements 7 push the heater members 6 against the first transmission belt 51 and the second transmission belt 52, respectively. As such, the heat produced from the heating elements 61 is conducted to the first transmission belt 51, the second transmission belt 52, and the pre-heat pieces 62.

As the object 8 runs between the first transmission belt 51 and the second transmission belt 52, the object 8 first reaches the pre-heat pieces 62 and is, as such, pre-heated by the pre-heat pieces 62. The object 8 then reaches the heating elements 61 where the object 8′s thermal sealing is achieved. The thermally sealed object 8 is then delivered out through the output slot 12. The object 8 is carried by the first transmission belt 51 and the second transmission belt 52, thereby moving a longer distance for heating. Together with the pre-heating offered by the pre-heat pieces 62, the heating elements 61 may achieve faster thermal sealing without wasting time in pre-heating, thereby enhancing the efficiency of the lamination device.

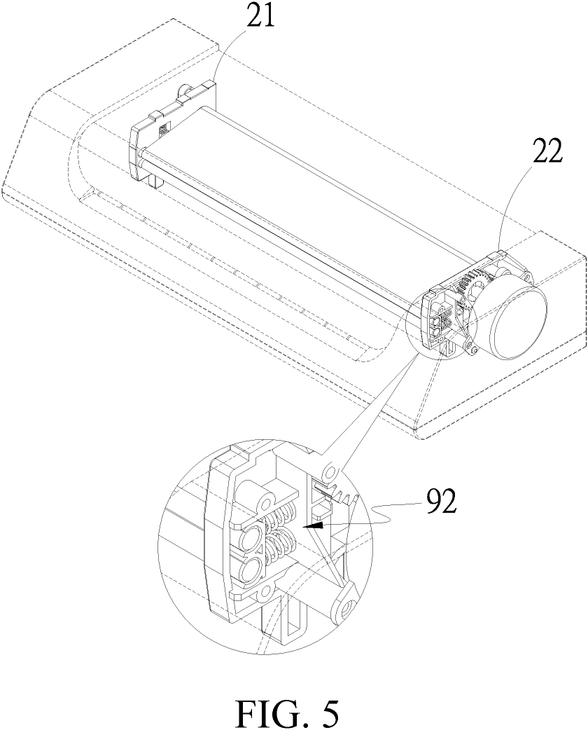

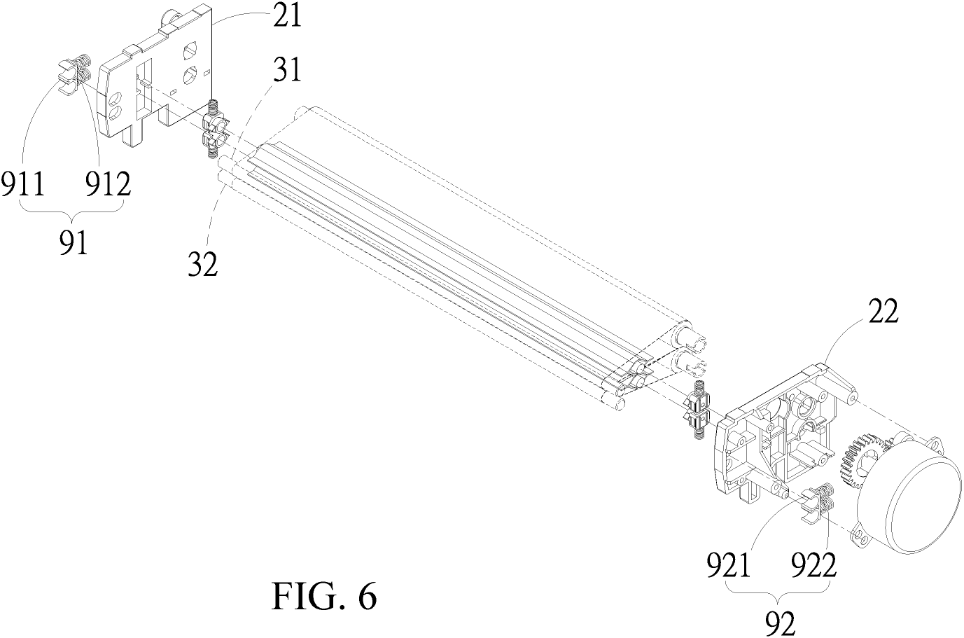

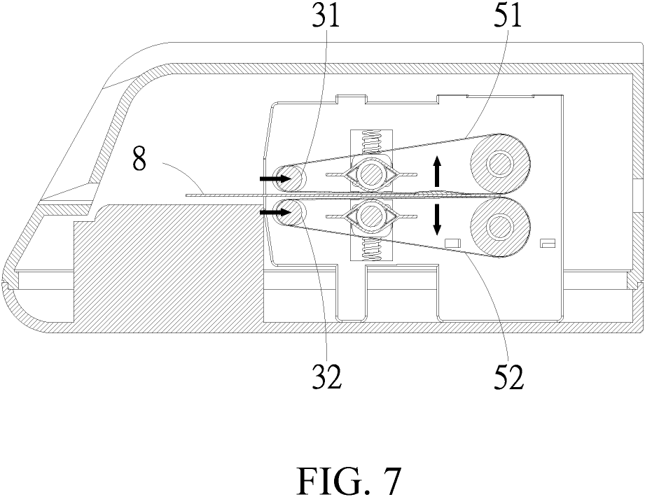

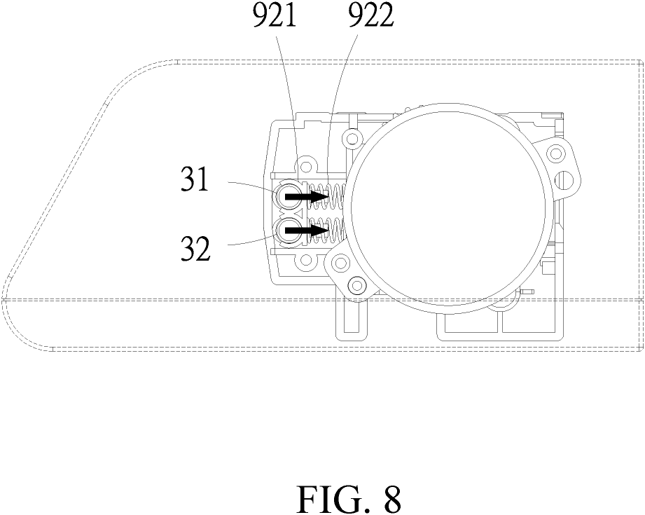

As shown in FIGS. 5 to 8, a second embodiment of the lamination device is similar to the previous embodiment except that the left plate 21 and the right plate 22 are respectively configured with a left elastic member 91 and a right elastic member 92. The left elastic member 91 includes a left stretching element 911 laterally contacting left ends of the first input shaft 31 and the second input shaft 32, and a number of left elastic elements 912 laterally pressing the left stretching element 911. The right elastic member 92 includes a right stretching element 921 laterally contacting the first input shaft 31 and the second input shaft 32, and a number of right elastic element 922 laterally pressing the right stretching element 921.

During the operation of the lamination device, the first input shaft 31 and the second input shaft 32 are pressed by the left stretching element 911 of the left elastic member 91 and the right stretching element 921 of the right elastic member 92 as they are pushed by the expansion of the left elastic elements 912 and the right elastic elements 922. As such, the first transmission belt 51 and the second transmission belt 52 are stretched and tightened, thereby increasing contact area between the object 8 and the first and second transmission belts 51 and 52, and making the movement of the object 8 more reliable and smoother. When the object 8 is too thick or has bulges, the object 8 may deform the first transmission belt 51 and the second transmission belt 52. In the present embodiment, the first input shaft 31 and the second input shaft 32 may compress the left elastic member 91 and the right elastic member 92 in response to the object 8′s thickness or unevenness so that the first transmission belt 51 and the second transmission belt 52 may still be completely attached to the object 8.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

1. A lamination device, comprising:
a main member;
an input slot on a front side of the main member;
an output slot on a back side of the main member opposite to the input slot;
a left plate inside the main member and adjacent to a left side of the main member;
a right plate inside the main member and adjacent to a right side of the main member opposite to the left plate;
a first input shaft inside the main member adjacent to the input slot whose two ends pivotally joined to the left plate and the right plate, respectively;
a second input shaft inside the main member adjacent to the input slot whose two ends pivotally joined to the left plate and the right plate, respectively;
a first output shaft inside the main member adjacent to the output slot whose two ends pivotally joined to the left plate and the right plate, respectively;
a second output shaft inside the main member adjacent to the output slot whose two ends pivotally joined to the left plate and the right plate, respectively;
a power element inside the main member coupling and engaging the first output shaft and second output shaft;
a first transmission belt surrounding the first input shaft and first output shaft;
a second transmission belt surrounding the second input shaft and second output shaft; and
a plurality of heater members inside the main member and respectively surrounded by the first transmission belt and the second transmission belt, where each heater member comprises a pre-heat piece wrapping the heater member, the pre-heat piece being operable to heat the first transmission belt and the second transmission belt;
wherein the left plate is configured with a left elastic member and the right plate is configured with a right elastic member;
wherein the left elastic member comprises a left stretching element laterally contacting left ends of the first input shaft and the second input shaft, and a plurality of left elastic elements laterally pressing the left stretching element; and the right elastic member comprises a right stretching element laterally contacting right ends of the first input shaft and the second input shaft, and a plurality of right elastic elements laterally pressing the right stretching element; and
wherein the first output shaft and the second output shaft have cross-sectional radiuses greater than those of the first input shaft and the second input shaft.

2-5. (canceled)

6. The lamination device according to claim 1, wherein the power element engages the first output shaft and the second output shaft through gears.

7. The lamination device according to claim 1, wherein each heater member has its two ends movably joined to the left plate and the right plate, respectively.

8. The lamination device according to claim 7, wherein a plurality of elastic support elements are respectively configured on the left plate and the right plate supporting the two ends of the heater members.

9. (canceled)
